(19) United States
(12) Patent Application Publication
(10) Pub. No.: US 2004/0226227 A1
(43) Pub. Date: Nov. 18, 2004

(54) Extendable aerial service wire mast

(76) Inventors: Carrie P. Johnson, Longwood, FL (US); Daniel M. Taylor, Deltona, FL (US)

Correspondence Address: KIRKPATRICK & LOCKHART LLP, 535 SMITHFIELD STREET, PITTSBURGH, PA, 15222, US

(21) Appl. No.: 10/436,511

(22) Filed: May 13, 2003

(51) Int. Cl. E04H 12/34; B66C 23/06

(52) U.S. Cl. 52/111; 52/146

(57) ABSTRACT

An apparatus for supporting an aerial service wire includes a mast capable of attachment to an aerial service wire. The mast may be extendable between at least a first position and a second position and connected to a clamp capable of attachment to a support structure. A method for supporting an aerial service wire includes attaching an extendable aerial service wire mast to a support structure, attaching an aerial wire to the extendable aerial service wire mast, and adjusting the height of the extendable aerial service wire mast.

### TECHNICAL FIELD

The present invention relates generally to equipment and methods for providing telecommunications services and, more particularly, to an extendable aerial service wire mast for addressing aerial service wire clearance problems.

### BACKGROUND

Service wires, such as electric supply lines and communication lines have long been used in aerial applications. Standards, such as the National Electrical Safety Code (NESC), have been adopted to ensure safety to operating personnel and the general public in the application of aerial service wires. For example, these standards subject the placement of aerial service wires to certain minimum clearances above ground in urban and rural areas.

Problems arise, however, where sufficient and safe clearance cannot be obtained by attaching aerial service wires directly to a building or structure. In the past, the problems of insufficient height or clearance for aerial service wires have been addressed in one of three ways. One way involved mounting a bracket on the power mast and attaching the aerial service wire to the bracket. NESC policies, however, have mandated that this option is no longer acceptable due to the possible dangers when using a power mast to attain sufficient height or clearance.

A second way to attain sufficient height or clearance involved attaching a “ramshorn” to a higher peak on the building or structure. In general, a ramshorn is an iron rod having one end inserted in an insulator (e.g., rubber, composition, or metal-clad glass) and the other end shaped like a ram's horn. The aerial service wire is secured to the insulator by threading it through the opposing “horns.” Sometimes this peak is far away from the outside network interface, however, which results in extra work for the technician who must run the aerial service wire from the peak around the eaves to the location of the outside network interface. This solution also requires the use of more materials (e.g., wire, drive rings, clamps). For aesthetic reasons, this solution caused customer dissatisfaction because wires from the house were not uniform due to the power drop being attached at one place on the house and telephone and television cable being attached at another.

A third way to attain sufficient height involved setting a new telephone pole between the house and the serving terminal. This engineering job was and is very costly to the responsible company or customer.

Accordingly, there exits the need for equipment and methods to provide sufficient and safe clearance for aerial service wires while avoiding possible dangers and/or expenses.

### SUMMARY

In one general aspect, an apparatus for supporting an aerial service wire includes a mast capable of attachment to an aerial service wire. The mast may be extendable between at least a first position and a second position and connected to a clamp capable of attachment to a support structure.

Implementations may include one or more of the following features. For example, the mast may include first and second telescoping portions, such as interlocking pipes, constructed from metal and/or plastic. The telescoping portions may include one or more holes. At least one hole may be used for attachment to an aerial service wire. One or more holes of the first telescoping portion may be aligned with one or more holes of the second telescoping portion. A locking member such as a bolt, a screw, a rod or a pin may be used to lock the first and second telescoping portions in the second position.

The clamp may include a bracket and/or telescoping side plates. The aerial service wire may include a service drop and/or an attachment member, such as a ramshorn. The support structure may be a building and/or include an interface for the aerial service wire.

In another general aspect, a method for supporting an aerial service wire includes attaching an extendable aerial service wire mast to a support structure, attaching an aerial wire to the extendable aerial service wire mast, and adjusting the height of the extendable aerial service wire mast.

Other features and advantages will be apparent from the following description, including the drawings, and from the claims.

### DESCRIPTION OF THE FIGURES

FIG. 1 illustrates one embodiment of an extendable aerial service wire mast according to the present invention.

FIG. 2 illustrates the use of a plurality of extendable aerial service wire masts according to the present invention.

FIG. 3 is a flowchart of one embodiment of a method for supporting an aerial service wire according to the present invention.

### DETAILED DESCRIPTION

In one aspect, an extendable aerial service wire mast provides extra height needed to gain proper clearance for aerial service wires on most buildings and structures. This avoids the need for pole placements and the unacceptable and dangerous practice of attaching aerial service wires to a power mast.

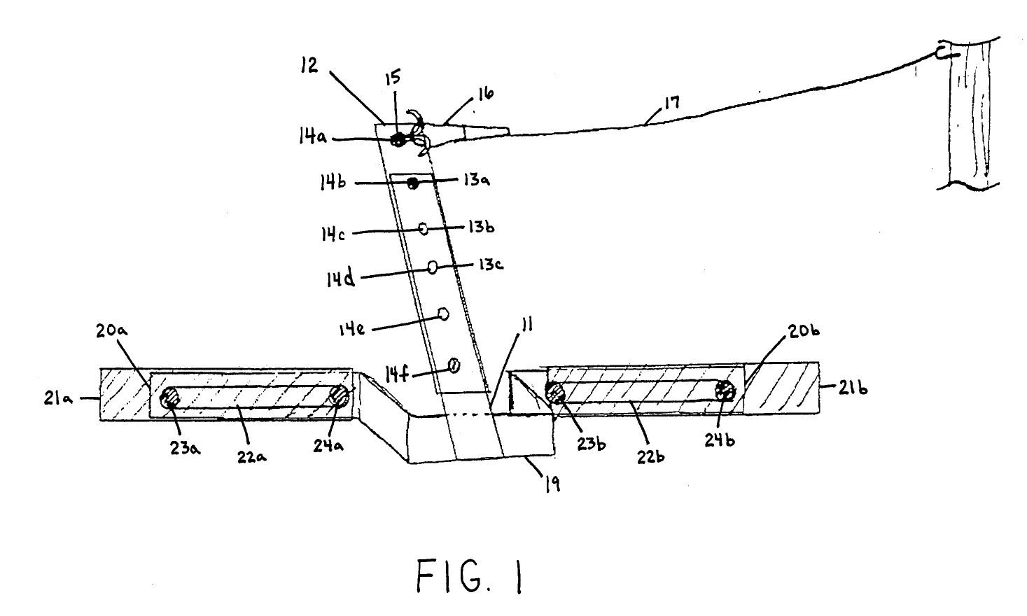

FIG. 1 illustrates one embodiment of an extendable aerial service wire mast 10. As shown, the extendable aerial service wire mast 10 includes a first (inner) pipe 11 and a second (outer) pipe 12. The inner pipe 11 and the outer pipe 12 may be constructed of galvanized steel pipe, for example. In other embodiments, different material such as corrugated plastic may be used.

In one implementation, the inner pipe 11 and the outer pipe 12 of the extendable aerial service wire mast 10 are in interlocking engagement. That is, the inner pipe 111 fits within the outer pipe 12 for telescoping effect. In other embodiments, however, the telescoping effect could be achieved by using a first (outer) pipe and a second (inner) pipe.

While the dimensions may vary depending upon the particular implementation, in one embodiment, the inner pipe 11 may have a length of approximately eighteen inches and a diameter of approximately two inches. The outer pipe 12 may have a length of approximately sixteen inches and a diameter marginally greater than the diameter of the inner pipe 11.

In general, the height of the extendable aerial service wire mast 10 may be adjustable to give aerial service wires needed height and/or clearance. In one embodiment, the height of the extendable aerial service wire mast 10 may be adjusted to approximately three feet. As shown, the inner pipe 11 may include a plurality of prefabricated threaded holes 13a-13c for accommodating different adjustable heights. In the embodiment of FIG. 1, the inner pipe 11 includes three holes 13a-13c, with the uppermost hole 13a being located approximately 1.5 inches below the top.

As mentioned above, the inner pipe 11 and the outer pipe 12 of the extendable aerial service wire mast 10 are in interlocking telescoping engagement. As shown in FIG. 1, the inner pipe 11 fits snugly within the outer pipe 12, and the top of the outer pipe 12 extends beyond the top of the inner pipe 11. The height of the extendable aerial service wire mast 10 may be adjusted, for example, by sliding the outer pipe 12 upward and connecting the inner pipe 11 and the outer pipe 12.

In one embodiment, the outer pipe 12 includes a plurality of prefabricated threaded holes 14a-14f. In this embodiment, the outer pipe includes six holes. A first locking member 15 may be positioned through the uppermost hole 14a of the outer pipe 12 to secure an attachment member 16 (e.g., ramshorn) to the outer pipe 12. The attachment member 16, in turn, may be connected to an aerial service wire 17. The locking member 15 may be any type of device configured to secure the attachment member 16 to the outer pipe 12. In general, the type of locking member 15 that is used may depend on the particular implementation. Examples include, but are not limited to a threaded bolt and nut, a screw, a rod, and a pin.

A second locking member 18 may be used to connect the inner pipe 11 to the outer pipe 12 when adjusting the height of the extendable aerial service wire mast 10. For example, by positioned the second locking member 18 through hole 14f of the outer pipe 12 and through hole 13a of the inner pipe 11, the maximum height of the extendable aerial service wire mast 10 is achieved. In general, however, the locking member 18 may be positioned through any one of holes 14b-14f of the outer pipe 12 and any one of holes 13a-13c to adjust the height of the extendable aerial service wire mast 10. The size and spacing of the holes 13a-c and holes 14b-14f may be substantially similar so as to allow for easy alignment. The locking member 18 may be any type of device (e.g., threaded bolt and nut, a screw, a rod, a pin, etc.) configured to secure the inner pipe 11 to the outer pipe 12.

As shown in FIG. 1, the extendable aerial service wire mast 10 also may include a clamp for securing the extendable aerial service wire mast 10 to a building or other structure. The clamp may be used, for example, to secure the extendable aerial service wire mast 10 to a house at a point where the fascia and the soffit meet. In one embodiment, the clamp includes a generally U-shaped bracket 19, a first (left) inner side plate 20a, a first (left) outer side plate 21a, a second (right) inner side plate 20b, and a second (right) outer side plate 21b.

In one implementation, the inner side plates 20a, 20b and corresponding outer side plates 21a, 21b may provide telescoping effect. The inner side plates 20a, 20b each may include a respective slot 22a, 22b for limiting the amount of extension. In one embodiment, the extension may be from approximately eighteen to thirty-five inches. The left outer side plate 21a may include holes 23a, 24a (e.g., predrilled screw holes) for receiving screws to attach the left inner side plate 20a and the left outer side plate 21a to a building or other structure. Similarly, the right outer side plate 21b may include holes 23b, 24b (e.g., predrilled screw holes) for receiving screws to attach the right inner side plate 20b and the right outer side plate 21b to a building or other structure.

As shown in FIG. 1, the inner pipe 11 may be angled relative to one of the inner side plates for added stability. In one embodiment, the inner pipe 11 may be angled at approximately 70° relative to the left inner side plate 20a. The extendable aerial service wire mast 10 may further include a stabilizing strap (not shown) when the mast is in the extended position to provide further stability.

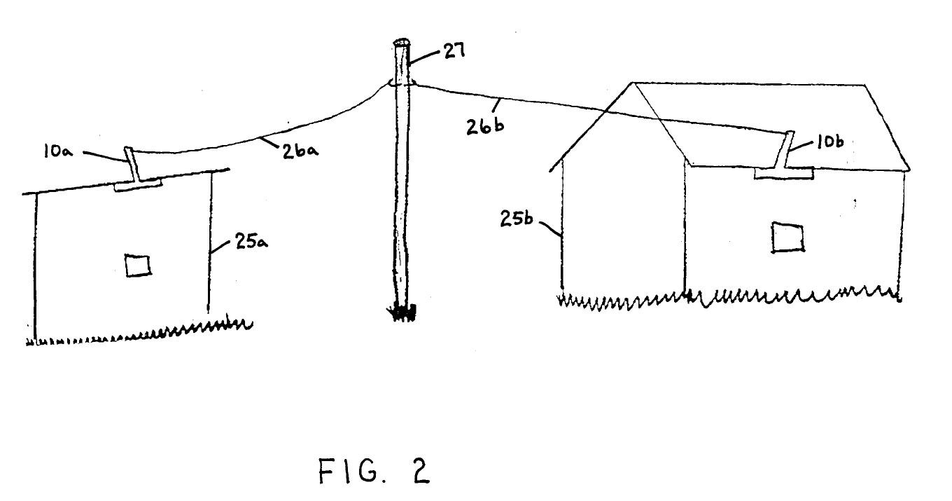

FIG. 2 illustrates use of a plurality of extendable aerial service wire masts according to one embodiment of the present invention. As shown, a first extendable aerial service wire mast 10a is attached to a first house 25a and a second extendable aerial service wire mast 10b is attached to a second house 25b. In one implementation, the first extendable aerial service wire mast 10a may connect to a first service drop 26a running from a utility pole 27. The second extendable aerial service wire mast 10a may connect to a second service drop 26b running from the utility pole 27. In general, a service drop includes one or more service lines (e.g., wires, cables) that run from a utility distribution point (e.g., distribution transformer, distribution cable) on a utility pole (e.g., electric pole, telephone pole) to a service entry point of a household or building.

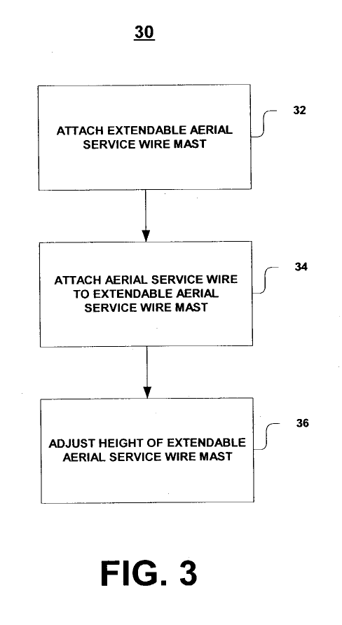

FIG. 3 illustrates a flow chart for one embodiment of a method 30 for supporting an aerial service wire. In general, supporting an aerial service wire with an extendable aerial service wire mast will provide the extra height needed to gain proper clearance for the aerial service wire on most buildings and structures. This avoids the need for pole placements and the unacceptable and dangerous practice of attaching the aerial service wire to a power mast.

At step 32, a technician attaches the extendable aerial service wire mast to a building or other structure. In one implementation, the extendable aerial service wire is attached using a clamp. For example, the clamp may be used to secure the extendable aerial service wire mast to a house at a point where the fascia and the soffit meet. In some cases, attaching the extendable aerial service wire mast may include adjusting the side plates of the clamp and using screws to secure the side plates to the building or structure.

At step 34, the technician attaches an aerial service wire to the extendable aerial service wire mast. In general, the aerial service wire may include an attachment member such as a ramshorn. In one implementation, the extendable aerial service wire mast may include a pipe having a prefabricated hole. A locking member such as a threaded bolt and nut, a screw, a rod, or a pin may be positioned through the hole of the pipe to secure the attachment member.

At step 36, the technician adjusts the height of the extendable aerial service wire mast. In general, the height of the extendable aerial service wire mast may be adjusted to provide safe and sufficient clearance. In one implementation, the extendable aerial service wire mast may include first and second pipes that are interlocking and in telescoping engagement. Adjusting the height of the extendable aerial service wire mast may include sliding one of the pipes upward and connecting the two pipes together. The pipes each may include prefabricated holes and may be connected together using a locking member such as a threaded bolt and nut, a screw, a rod, or a pin.

When attached to an aerial service wire and a building, the aerial service wire mast provides safe and sufficient clearance for service drops. Accordingly, the extendable aerial service wire mast may be used to address problems where sufficient and safe clearance cannot be obtained by attaching the wire directly to the building or structure at the nearest point where the outside network interface is placed. Technicians also would avoid possible danger and/or expenses that might be incurred by using the power mast in order for the aerial service wire to attain sufficient height or clearance.

As described and illustrated, aspects of the present invention provide an improvement over past and current equipment and methods. Namely, the extendable wire service mast may provide the extra height needed to gain proper clearance for aerial service wires on most buildings and structures while avoiding the need for pole placements and the unacceptable and dangerous practice of attaching aerial service wires to a power mast.

A number of implementations have been described. Nevertheless, it will be understood that various modifications may be made and that other implementations are within the scope of the following claims. For example, the extendable aerial service wire mast may be used by other utilities such as, for example, television cable companies that have a similar need to attach service drops to buildings with safe and sufficient clearance.

What is claimed is:

1. An apparatus for supporting an aerial service wire, the apparatus comprising:
a mast capable of attachment to an aerial service wire, the mast being extendable between at least a first position and a second position; and
a clamp connected to the mast and capable of attachment to a support structure.

2. The apparatus of claim 1, wherein the mast comprises first and second telescoping portions.

3. The apparatus of claim 2, wherein the telescoping portions comprise interlocking pipes.

4. The apparatus of claim 2, wherein at least one telescoping portion comprises metal.

5. The apparatus of claim 2, wherein at least one telescoping portion comprises plastic.

6. The apparatus of claim 2, wherein the first telescoping portion includes one or more holes.

7. The apparatus of claim 6, wherein the first telescoping portion includes at least one hole capable of attachment to an aerial service wire.

8. The apparatus of claim 6, wherein the second telescoping portion comprises one or more holes.

9. The apparatus of claim 8, wherein one or more holes of the first telescoping portion are aligned with one or more holes of the second telescoping portion.

10. The apparatus of claim 1, further comprising a locking member for locking the first and second telescoping portions in the second position.

11. The apparatus of claim 10, wherein the locking member comprises at least one of a bolt, a screw, a rod, and a pin.

12. The apparatus of claim 1, wherein the clamp comprises a bracket.

13. The apparatus of claim 1, wherein the clamp comprises telescoping side plates.

14. The apparatus of claim 1, wherein the aerial service wire comprises a service drop.

15. The apparatus of claim 1, wherein the aerial service wire comprises an attachment member.

16. The apparatus of claim 15, wherein the attachment member comprises a ramshorn.

17. The apparatus of claim 1, wherein the support structure comprises a building.

18. The apparatus of claim 1, wherein the support structure comprises an interface for the aerial service wire.

19. A method for supporting an aerial service wire comprising:
attaching an extendable aerial service wire mast to a support structure;
attaching an aerial wire to the extendable aerial service wire mast; and
adjusting the height of the extendable aerial service wire mast.

20. An apparatus comprising:
extending means for extending between at least a first position and a second position; and
attaching means for attaching to a support structure, wherein the extending means is connected to an aerial service wire and the attaching means.
